(19) United States
(12) Patent Application Publication
(10) Pub. No.: US 2004/0208639 A1
(43) Pub. Date: Oct. 21, 2004

(54) System and method for parallel angle multiplexing

(76) Inventors: Volker Melzer, Munich (DE); Tobias Damm, Munchen (DE); Peter Mueller, Mering (DE); Ralph Thoma, Augsburg (DE)

Correspondence Address: Agfa Corporation, Law & Patent Department, 200 Ballardvale Street, Wilmington, MA, 01887-1069, US

(21) Appl. No.: 10/218,935

(22) Filed: Aug. 14, 2002

Related U.S. Application Data
(60) Provisional application No. 60/394,129, filed on Jul. 3, 2002.

(51) Int. Cl. H04J 14/08; H04B 10/04

(52) U.S. Cl. 398/183

(57) ABSTRACT

A communication system is disclosed that includes a modulator and a collection unit. The modulator modulates a first electromagnetic signal having a first frequency when the modulator has a first grating period and produces a first modulated electromagnetic signal. The modulator modulates a second electromagnetic signal having a second frequency when the modulator has a second grating period that is different than the first grating period and produces a second modulated electromagnetic signal. The modulator modulates a electromagnetic signal having a frequency when the modulator has a first grating period and produces a first modulated electromagnetic signal which is directed in first direction. The modulator modulates a electromagnetic signal having the same frequency when the modulator has a second grating period and produces a second modulated electromagnetic signal which is directed in second direction. In various embodiments, the system may electromagnetic signals having different frequencies, modulators having different grating periods, and/or collection units for collecting modulated signals at different angular directions with respect to the modulator.

This Application claims priority to U.S. Provisional Application Ser. No. 60/394,129 filed Jul. 3, 2002.

### BACKGROUND OF THE INVENTION

The invention generally relates to communication systems in which information is transmitted via optical fibers, and relates in particular to signal switching systems for such communication systems.

Although fiber optic communication systems are able to transmit a large volume of information at a very high rate and are able to simultaneously transmit a plurality of signals in a single optical fiber, communication systems employing fiber optics must process the signal at transmitter and receiver ends of a optical fiber transmission path or at any detection system. The processing of such signals by transmitters and receivers is typically very slow compared to the speed at which the communication signals travel along the optical fibers. The processing of the signals by transmitters and receivers involves not only modulating/demodulating the signals (typically from/to another format such as analog or digital electronic signals), but also combining/separating different signals that are transmitted along a common optical fiber.

Devices for processing signals for fiber optic communication include transmitters that separately modulate different signals and then combine the separately modulated different signals for transmission along an optical fiber. For example, U.S. Pat. No. 6,342,960 discloses a system that divides a broadband wavefront into a plurality of signals of different frequencies using a diffraction grating and a plurality of independent grating light valve (GLV) modulators for separately modulating each different signal. Such a system, however, has a static variation of diffraction period and requires very precise calibration of the diffraction grating and reflectors to ensure that each different frequency signal contacts the appropriate GLV from exactly the correct angle. In fact, the system further discloses that a calibration detector array may be used to detect misalignment of the reflector module assembly.

There is a need, therefore, for an efficient and economical system and method for processing communication signals that are transferred with optical fibers.

### SUMMARY OF THE INVENTION

The invention provides a communication system that includes a modulator and a collection unit. The modulator modulates a first electromagnetic signal having a first frequency when the modulator has a first grating period and produces a first modulated electromagnetic signal. The modulator modulates a second electromagnetic signal having a second frequency when the modulator has a second grating period that is different than the first grating period and produces a second modulated electromagnetic signal. The collection unit is for collecting the first and second modulated electromagnetic signals for transmission. In various embodiments, the system may include electromagnetic signals having different frequencies, modulators having different grating periods, and/or collection units for collecting modulated signals at different angular directions with respect to the modulator. For example, in accordance with an embodiment, the invention provides a communication system that includes a modulator and a collection unit. The modulator modulates a electromagnetic signal having a narrow bandwidth frequency when the modulator has a first grating period and produces a first modulated electromagnetic signal that is directed in first direction. The modulator modulates an electromagnetic signal having the same narrow bandwidth frequency when the modulator has a second grating period and produces a second modulated electromagnetic signal that is directed in a second direction. Both multiplexing techniques may be performed by the same communication system device, or may be employed separately.

### BRIEF DESCRIPTION OF THE DRAWINGS

The following description may be further understood with reference to the accompanying drawings in which:

FIG. 1 shows an illustrative diagrammatic view of a communication system in accordance with an embodiment of the invention;

FIGS. 2A and 2B show illustrative diagrammatic views of the ribbons of a gradient light valve modulator having a spacing of Δ₁ in accordance with an embodiment of the invention;

FIGS. 3A and 3B show illustrative graphical views of the intensity distribution in the Fourier plane for a non-activated grating and an activated grating;

FIGS. 4A and 4B show illustrative diagrammatic views of the ribbons of a gradient light valve modulator having a spacing of Δ₂ in accordance with an embodiment of the invention;

FIGS. 5A and 5B show illustrative diagrammatic views of the ribbons of a gradient light valve modulator having a spacing of Δ₃ in accordance with an embodiment of the invention;

FIG. 6 shows an illustrative diagrammatic view of a timing chart for a communication system in accordance with an embodiment of the invention;

FIG. 7 shows an illustrative diagrammatic view of a communication system in accordance with another embodiment of the invention; and

FIG. 8 shows an illustrative diagrammatic view of a communication system in accordance with a further embodiment of the invention.

The drawings are shown for illustrative purposes only.

### DETAILED DESCRIPTION OF THE INVENTION

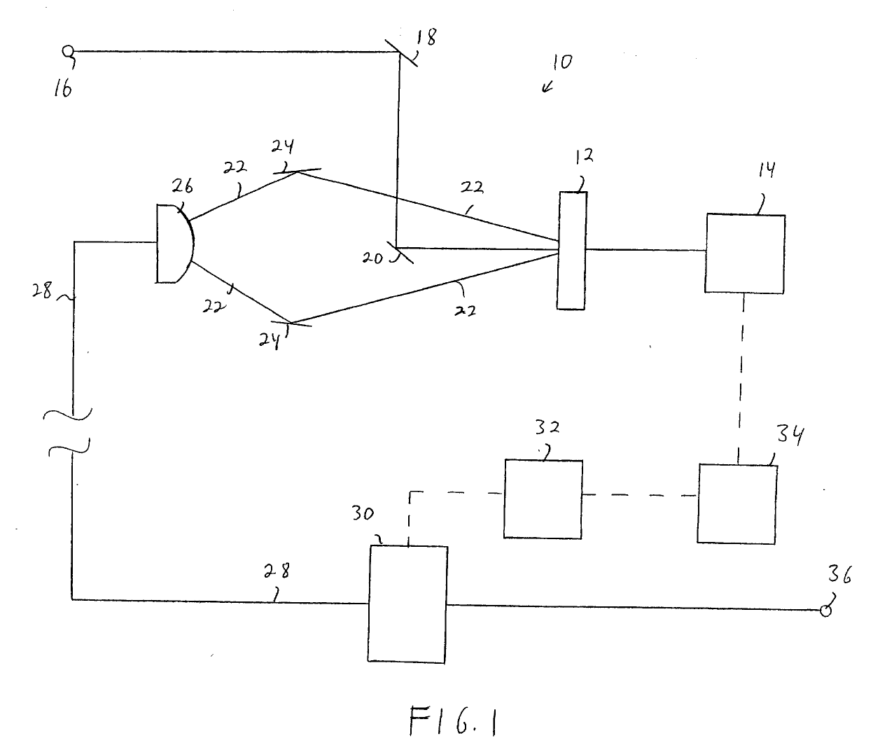

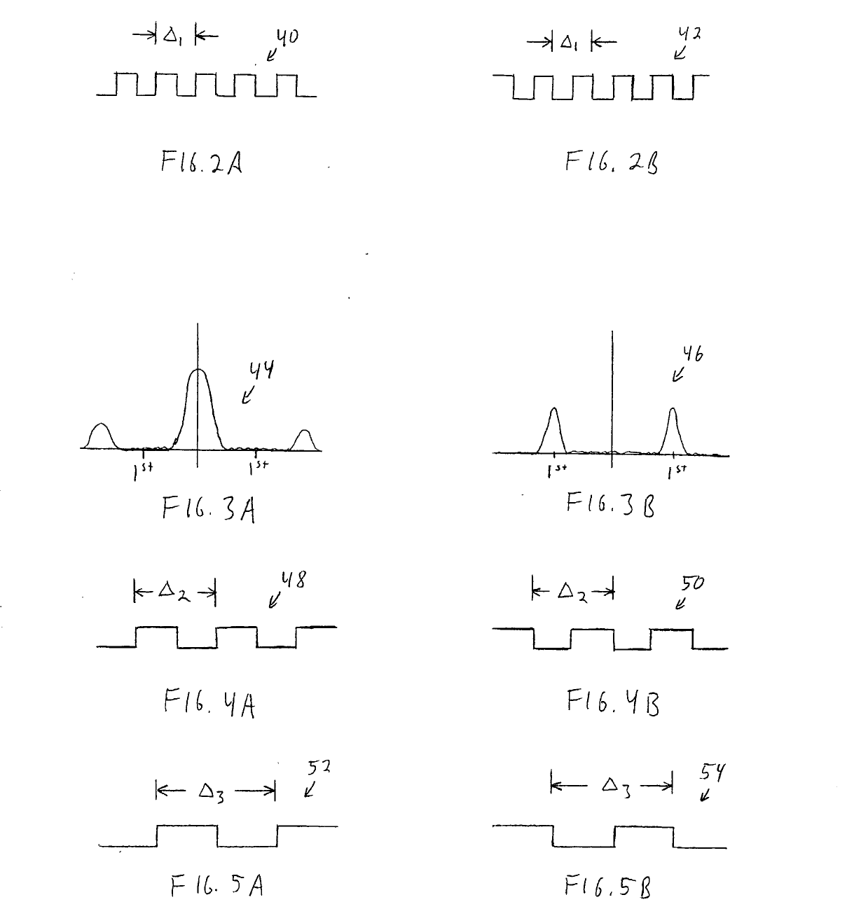

As shown in FIG. 1, a communication system 10 in accordance with an embodiment of the invention includes a light modulator 12 in communication with a transmitter controller 14. A multi-frequency carrier signal is received at input 16 and directed toward the modulator 12 via reflectors 18 and 20. The modulator 12 is, for example, a GLV having a time varying grating period. In various embodiments, the modulator may be reflective or transmissive, e.g., by using a transmission LCD. The diffraction relationship between the grating period and the diffraction angle is defined as:

$$sin {α}_{MAX} = k \frac{λ}{Δ}$$

where kεN, α_{MAX} is the diffraction angle, λ is the wavelength of the carrier signal, and Δ is the grating period. If the grating period is variable in time, the diffractive light modulator can switch or modulate the diffraction angle. When using a grating light valve all ribbons should be controlled to realize variable grating periods. Controlled formation of groups of activated and non-activated ribbons (ribbon patterns) results in different grating periods. In further embodiments, the angle of incidence of the carrier signal or signals onto the modulator may be varied by, for example, adjusting the positions of the mirrors 18 and 20 or using other adjustable optics. The dynamic variability of grating period can be either used for wavelength separation or combination or for direction multiplexing (variation of diffraction angle due to variation of grating period) of a single wavelength and parallel to this for time multiplexed modulation.

The modulated light 22 from modulator 12 is directed by reflectors 24 (or lenses) toward fiber optic coupling optics 26 into an optical fiber 28. The optical fiber 28 carries the time division multiplexed multi-frequency signals to a receiver that may include a detector 30 and a receiver controller 32. The receiver controller 32 and the transmitter controller 14 are commonly coupled to a timing controller 34 as shown in FIG. 1. The receiver output signal is provided at the output port 36.

The operation of the system may be characterized by the following relationship

$${θ}_{ra d} = \frac{{λ}_{j}}{2 {Δ}_{j}}$$

where θ_{rad} is the spectral angle of the signal from the modulator 12, λⱼ is the wavelength of the carrier signal at each frequency and Δⱼ is the grating period for each wavelength λⱼ. Generally, different frequency carrier signals λⱼ may be designed to provide first order spectral reflection at the same angle θ_{rad} by adjusting the period of the grating Δⱼ. The carrier signals λⱼ are modulated by the modulator 12 to produce blocks of digital information that is time division multiplexed among the different carrier signals.

In particular, the modulator 12 may provide a grating period of Δ₁ and be switchable as shown at 40 and 42 in FIGS. 2A and 2B to provide the responses 44 and 46 shown in FIGS. 3A and 3B respectively. Specifically, when the grating appears as shown at 40 in FIG. 2A the response to a carrier signal λ₁ may be as shown at 44 in FIG. 3A including virtually no response in the first order, whereas when the grating appears as shown at 42 in FIG. 2B the response maybe as shown at 46 in FIG. 3B including a strong first order response. If the first order response is detected, the system may produce digital information (with comparatively low modulation speed) by switching the grating back and forth between the states as shown in FIGS. 2A and 2B using the grating period of Δ₁.

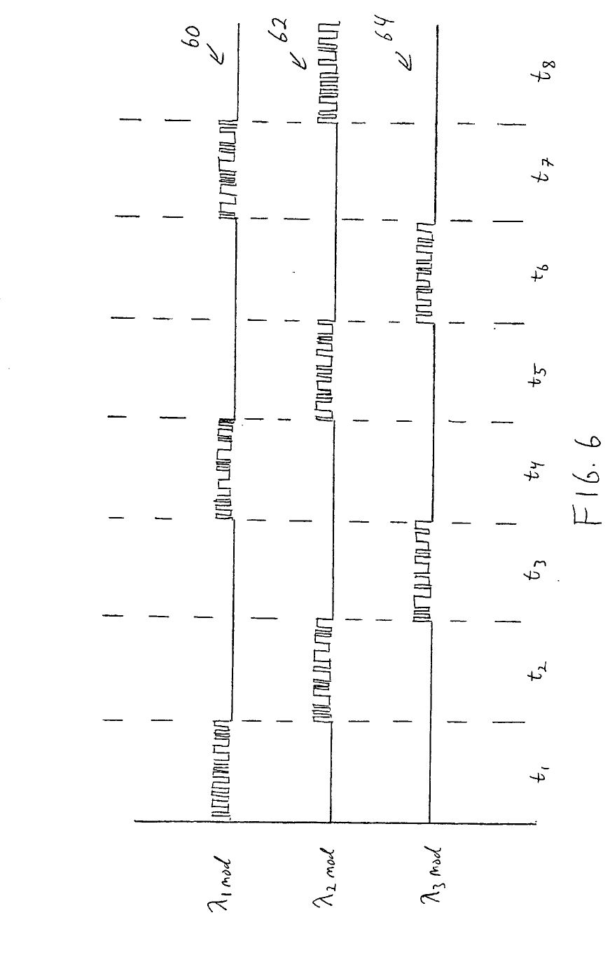

As shown at 48 and 50 in FIGS. 4A and 4B, the grating period may be changed to be Δ₂=2Δ₁ by pairing adjacent ribbons. If the values of θ_{rad}, λⱼ and Δⱼ are properly chosen, the first order response angle for the carrier signal λ₂ using a grating period of Δ₂ will be the same as for λ₁ using the grating period Δ₁ (of, for example, 3-5 microns). Similarly, the grating period may be changed to be Δ₃=3Δ₁ as shown at 52 and 54 in FIGS. 4A and 4B, and with properly chosen values for θ_{rad}, λⱼ and Δⱼ the first order response angle for the carrier signal λ₃ using a grating period of Δ₃ will be the same as for λ₁ using the grating period of Δ₁. This permits each carrier signal λⱼ to provide a modulated first order response at the same angle θ_{rad}. These modulated signals may be time division multiplexed by timing the modulator to provide the grating period Δ₁ at times t₁, t₄, t₇ etc., to provide the grating period Δ₂ at times t₂, t₅, t₈ etc., and to provide the grating period Δ₃ at times t₃, t₆ etc. In particular, as shown at 60 in FIG. 6, the modulated λ₁ signal includes digital information during times t₁, t₄, t₇ etc. As shown at 62 in FIG. 6, the modulated λ₂ signal includes digital information during times t₂, t₅, t₈ etc. As shown at 64 in FIG. 6, the modulated λ₃ signal includes digital information during times t₃, t₆ etc. The system, therefore, permits multiple signals to be modulated and combined at high speeds using the above relationship between θ_{rad}, λⱼ and Δⱼ.

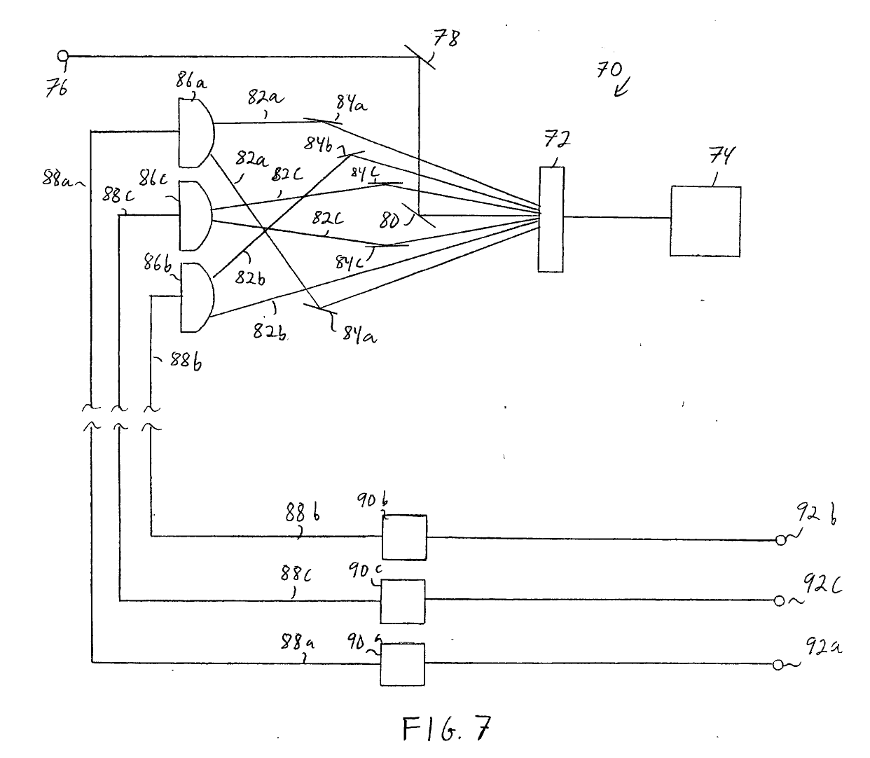

As shown in FIG. 7, a system 70 in accordance with a further embodiment of the invention includes a light modulator 72 in communication with a transmitter controller 74. A carrier signal is received at input 76 and directed toward the modulator 72 via reflectors 78 and 80. The modulator 72 may be a GLV having a time varying grating period. The diffraction relationship between the grating period and the diffraction angle may be as defined above.

The modulated light 82a-82c from modulator 72 is directed by reflectors 84a-84c toward fiber optic coupling optics 86a-86c respectively where the modulated light is coupled into each of optical fibers 88a-88c respectively. The optical fibers carry the signals to receivers that may include detectors 90a-90c and output ports 96a-96c respectively as shown. The signals may or may not be time-division multiplexed as required.

The operation of this system may be characterized by the following relationship

$${θ}_{ra {d}_{j}} = \frac{λ}{2 {Δ}_{j}}$$

where θ_{rad}_{ⱼ} is the spectral angle of the signal from the modulator 72 when the modulator has a grating period j, λ is the wavelength of the carrier signal and Δⱼ is each grating period j. Generally, the carrier signal λ provides first order spectral reflection at the angle θ_{rad}_{ⱼ} when the grating period is Δⱼ. The carrier signal λ is modulated by the modulator 72 to produce blocks of digital information that is time division multiplexed along each of the different optical fibers 88a-88c.

Specifically, the modulator 72 may provide a grating period of Δ₁ and be switchable to provide digital data using the first order response 82a at an angle of θ_{rad}_{₁} that is directed via reflectors 84a toward fiber optic coupler 86a. When the grating period is set to Δ₂ digital data is provided using the first order response 82b at an angle of θ_{rad}_{₂} that is directed via reflector 84b toward fiber optic coupler 86b. When the grating period is set to Δ₃ digital data is provided using the first order response 82c at an angle of θ_{rad}_{₃} that is directed via reflectors 84c toward fiber optic coupler 86c. The different signals may be time division multiplexed as discussed above with reference to FIG. 1.

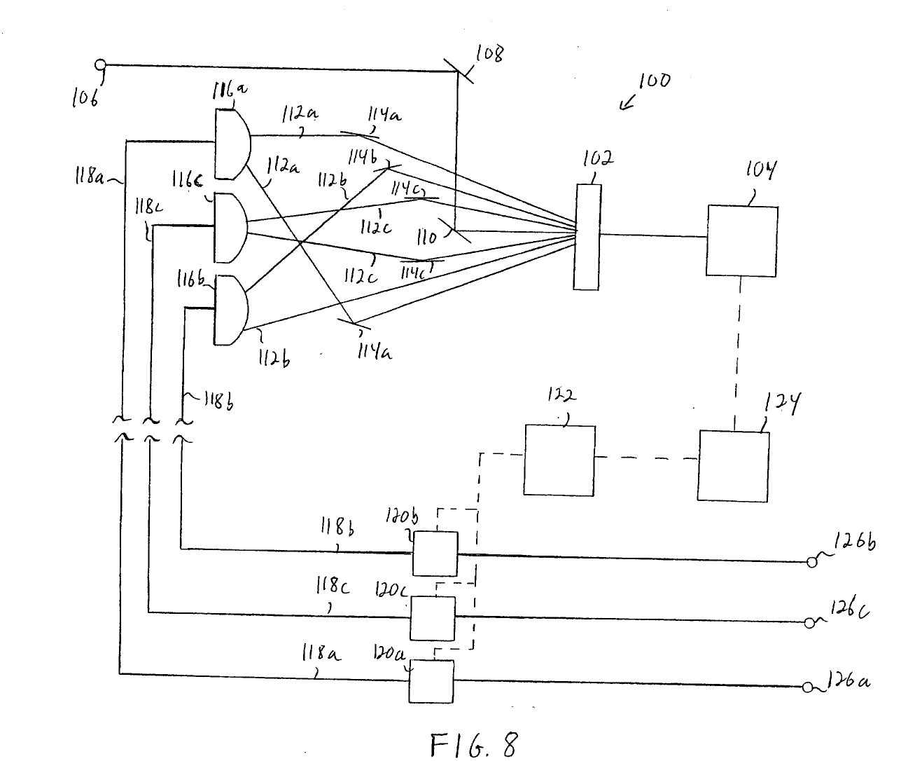

As shown in FIG. 8, a system 100 in accordance with a further embodiment of the invention includes a light modulator 102 in communication with a transmitter controller 104. A multi-frequency carrier signal is received at input 106 and directed toward the modulator 102 via reflectors 108 and 110. The modulator 102 may be a GLV having a fixed grating period A. The diffraction relationship between the carrier frequency, grating period and diffraction angle may be as defined above.

The modulated light 112a-112c from modulator 102 is directed by reflectors 114a-114c toward fiber optic coupling optics 116a-116c respectively where the modulated light is coupled into each of optical fibers 118a-118c respectively. The optical fibers carry the time division multiplexed signals to receivers that may include detectors 120a-120c and a receiver controller 122. The receiver controller 122 and the transmitter controller 104 are commonly coupled to a timing controller 124 as shown in FIG. 8. The receiver output signal is provided at the output ports 126a-126c respectively as shown.

The operation of this system may be characterized by the following relationship

$${θ}_{ra {d}_{j}} = \frac{{λ}_{j}}{2 Δ}$$

where θ_{rad} _{ⱼ} is the spectral angle of the signal from the modulator 72 when the wavelength of the carrier signal is λⱼ. Generally, each carrier signal λⱼ provides first order spectral reflection at the angle θ_{rad}_{ⱼ} when the grating period is fixed at Δ. Each carrier signal λⱼ is modulated by the modulator 102 to produce blocks of digital information that is time division multiplexed along each of the different optical fibers 118a-118c.

Specifically, the modulator 102 having a grating period of Δ may be switchable to provide digital data using the first order response 112a of a first carrier signal having a wavelength λ₁ at an angle of θ_{rad}_{₁} that is directed via reflectors 114a toward fiber optic coupler 116a. For the input carrier signal having a wavelength λ₂ the digital data is provided using the first order response 112b at an angle of θ_{rad}_{₂} that is directed via reflector 114b toward fiber optic coupler 116b. For the input carrier signal having a wavelength λ₃ digital data is provided using the first order response 112c at an angle of θ_{rad}_{₃} that is directed via reflectors 114c toward fiber optic coupler 116c. The different signals may be time division multiplexed as discussed above with reference to FIG. 1.

In further embodiments, each of the values θ_{rad}, λ and Δ maybe variable to achieve further systems of increased flexibility and functionality. Those skilled in the art will appreciate that numerous modifications and variations may be made to the above disclosed embodiments without departing from the spirit and scope of the present invention.

What is claimed is:

1. A communication system comprising:
a modulator for modulating a first electromagnetic signal having a first frequency when said modulator has a first grating period and producing a first modulated electromagnetic signal, and for modulating a second electromagnetic signal having a second frequency when said modulator has a second grating period that is different than said first grating period and producing a second modulated electromagnetic signal; and
collection means for collecting said first and second modulated electromagnetic signals for transmission.

2. A communication system as claimed in claim 1, wherein said first modulated electromagnetic signal is provided by said modulator at a first angle.

3. A communication system as claimed in claim 1, wherein said second modulated electromagnetic signal is provided by said modulator at a second angle.

4. A communication system as claimed in claim 1, wherein said first angle is equal to said second angle.

5. A communication system as claimed in claim 1, wherein said first and second modulated signals are time division multiplexed.

6. A communication system as claimed in claim 1, wherein said collection means includes an fiber optic coupler.

7. A communication system as claimed in claim 1, wherein said first and second modulated electromagnetic signals include information representative of digital data.

8. A communication system comprising:
a modulator for modulating a first electromagnetic signal having a first frequency when said modulator has a first grating period and producing a first modulated electromagnetic signal, and for producing a second modulated electromagnetic signal when said modulator has a second grating period that is different than said first grating period; and
collection means for collecting said first and second modulated electromagnetic signals for transmission.

9. A communication system as claimed in claim 8, wherein said first modulated electromagnetic signal is provided by said modulator at a first angle and said second modulated electromagnetic signal is provided by said modulator at a second angle that is different than said first angle.

10. A communication system as claimed in claim 8, wherein said first modulated electromagnetic signal is a first order reflected signal.

11. A communication system as claimed in claim 8, wherein said second modulated electromagnetic signal is a first order reflected signal.

12. A communication system as claimed in claim 8, wherein said collection means includes a fiber optic coupler.

13. A communication system as claimed in claim 8, wherein said first and second modulated electromagnetic signals include information representative of digital data.

14. A communication system comprising:
a modulator for modulating a first electromagnetic signal having a first frequency and producing a first modulated electromagnetic signal at a first angle with respect to said modulator, and for modulating a second electromagnetic signal having a second frequency and producing a second modulated electromagnetic signal at a second angle with respect to said modulator; and
collection means for collecting said first and second modulated electromagnetic signals for transmission.

15. A communication system as claimed in claim 14, wherein said first modulated electromagnetic signal is a first order reflected signal.

16. A communication system as claimed in claim 14, wherein said second modulated electromagnetic signal is a first order reflected signal.

17. A communication system as claimed in claim 16, wherein said modulator is a reflective modulator.

18. A communication system as claimed in claim 16, wherein said modulator is a transmissive modulator.

19. A communication system as claimed in claim 14, wherein said first modulated electromagnetic signal is a second or higher order reflected signal.

20. A communication system as claimed in claim 14, wherein said second modulated electromagnetic signal is a second or higher order reflected signal.

21. A communication system as claimed in claim 14, wherein said system further includes a receiver controller and a transmitter controller that are commonly coupled to a timing controller.
